(19) United States
(12) Patent Application Publication
(10) Pub. No.: US 2016/0228995 A1
(43) Pub. Date: Aug. 11, 2016

(54) MATERIAL REPAIR PROCESS USING LASER AND ULTRASOUND

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/614,767

(22) Filed: Feb. 5, 2015

(51) Int. Cl. B23K 31/02; B23K 20/10; B23K 26/34

(52) U.S. Cl. CPC B23K 31/02; B23K 26/34; B23K 20/10

(57) ABSTRACT

A process for repair of a surface (32) of a substrate (30) including the application of an energy beam (40) and vibratory mechanical energy (42) to the surface in a region of a discontinuity (34) in order to form a renewed surface (48) on the substrate. A powdered flux material (36) may be disposed over the discontinuity and melted in order to trap and remove contaminants (28) into a layer of slag (46). The vibratory mechanical energy may be applied to dislodge contaminants within the discontinuity, to add friction heat to the discontinuity, to assist in the flotation of the slag, to remove solidified slag, and/or to provide stress relief of the renewed surface.

### FIELD OF THE INVENTION

This invention relates generally to the field of materials technology, and more particularly to processes for the repair of a discontinuity in a substrate material.

### BACKGROUND OF THE INVENTION

Gas turbine hot gas path components are often subject to service-induced degradation in spite of being manufactured from highly durable superalloy materials. The term “superalloy” is used herein as it is commonly used in the art, i.e., a highly corrosion and oxidation resistant alloy that exhibits excellent mechanical strength and resistance to creep at high temperatures. Superalloys typically include a high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM247LC, C263, 718, X-750, ECY 768, 282, X45, PWA 1483 and CMSX (e.g., CMSX-4) single crystal alloys.

FIG. 1 illustrates an exemplary service-induced discontinuity as a crack 10 opening to a surface 12 of a superalloy substrate 14. A known method of repairing such cracks is laser remelting, as is illustrated in FIG. 2 where a laser beam 16 is directed to the surface 12 to heat and melt it to form a melt pool 18. The melt pool 18 encompasses the crack 10, such that upon removal of the laser beam 16 and cooling and solidification of the melt pool 18, a renewed surface 20 is formed on the substrate 14, as illustrated in FIG. 3.

The known process of FIGS. 1-3 is not always successful in providing a discontinuity-free surface 20. As illustrated in FIG. 3, artifacts of the laser remelting process may include porosity 22, inclusions 24 and/or solidification cracks 26. Such artifacts may result from the presence of contaminants 28 that accumulate in the original crack 10 during service exposure, such as oxides and other foreign debris present in the hot combustion gas of a gas turbine engine. The contaminants 28 mix into the melt pool 18 and may be distributed over a larger volume, but they are not eliminated by the laser remelting process. Pre-melt cleaning of the substrate surface 12 can reduce the quantity of the contaminants 28, but such cleaning requires advanced and expensive measures such as hydrogen, vacuum or fluoride ion heat treatment. Even after a cleaning process, tight and/or deep cracks are generally incompletely cleaned.

Crack prone materials, including superalloys often used in gas turbine engines, are also subject to the formation of cracking 26 as a result of a laser remelting process or a subsequent heat treatment, due to the restraint of the surrounding substrate material as the melt pool 18 cools and shrinks. Certain contaminants 28 can exacerbate this problem. Thus, there continues to be a need for an improved process for repairing a substrate material containing surface and near-surface discontinuities.

### BRIEF DESCRIPTION OF THE DRAWINGS

The invention is explained in the following description in view of the drawings that show:

FIG. 1 is a cross-sectional illustration of a prior art substrate material containing a surface-opening crack.

FIG. 2 illustrates a prior art laser remelting repair process.

FIG. 3 illustrates the substrate material of FIG. 1 after undergoing the laser remelting process of FIG. 2.

FIG. 4 illustrates a cracked substrate material covered by a layer of powdered material including flux and adjoined to an ultrasonic transducer.

FIG. 5 illustrates the substrate material of FIG. 4 being exposed to laser beam energy and ultrasonic energy to form a melt pool covered by a layer of slag.

FIG. 6 illustrates the substrate material of FIGS. 4 and 5 upon re-solidification of the melt pool and layer of slag.

FIG. 7 illustrates the substrate material of FIGS. 4-6 after removal of the layer of slag to reveal a renewed surface having no crack or other discontinuity.

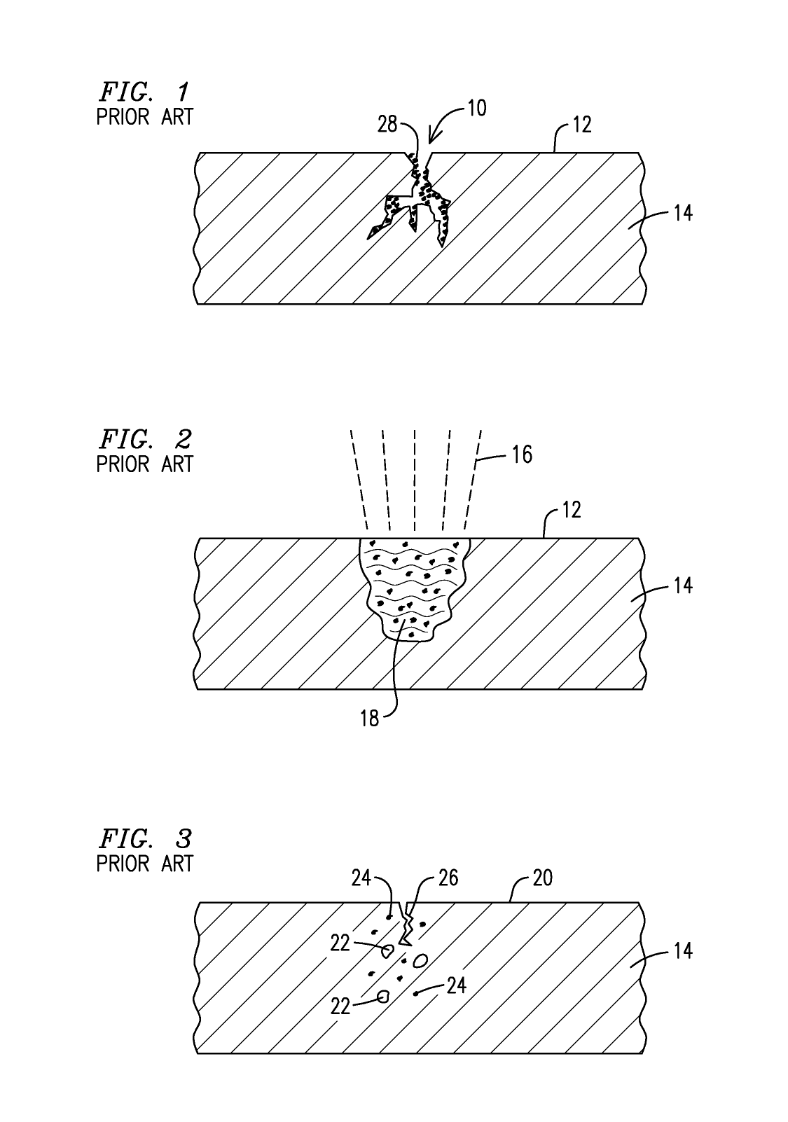

### DETAILED DESCRIPTION OF THE INVENTION

The present inventors have developed a hybrid process for repairing a material substrate which contains a discontinuity, such as a surface or subsurface crack, pit, inclusion, void, porosity, or other off-design condition. This process applies both an energy beam and vibratory mechanical energy in the region of the discontinuity in order to produce a renewed substrate surface free of the discontinuity and less susceptible to undesirable repair artifacts than can be achieved with prior art laser remelting processes. The utilization of both an energy beam and vibratory mechanical energy can improve the removal of harmful contaminants present in the discontinuity, can improve the control of the introduction of heat energy into the repaired material, and can reduce residual stresses in the substrate material resulting from the repair process.

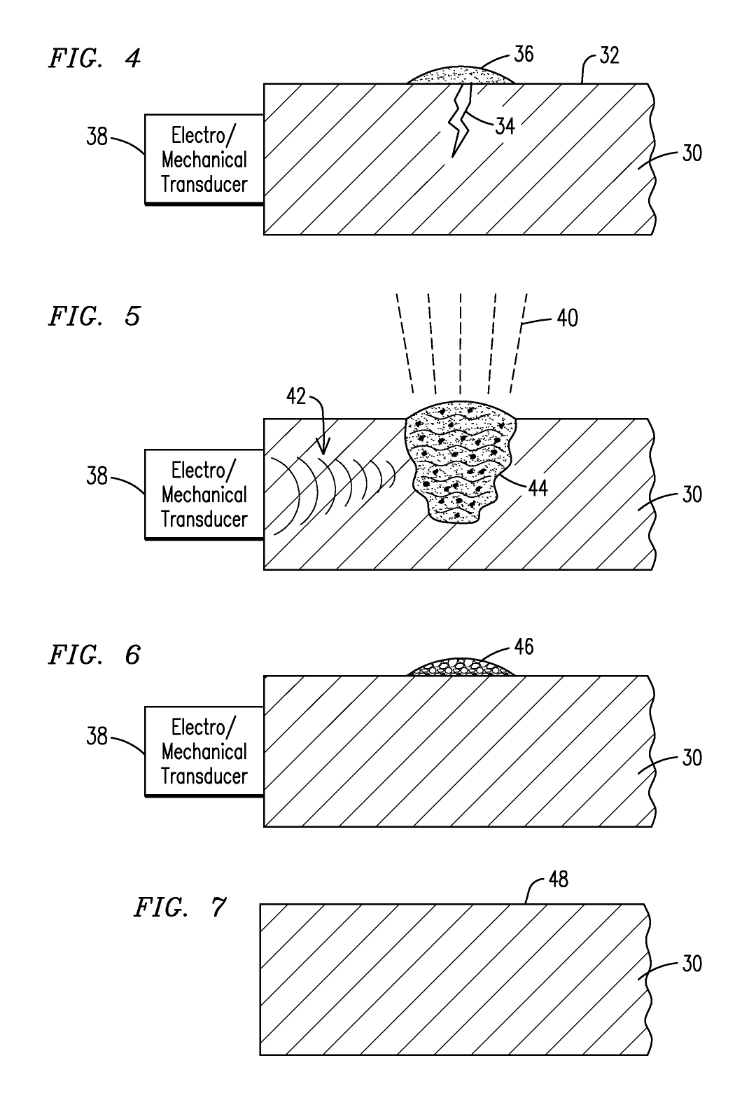

FIGS. 4-7 illustrate an embodiment of the invention. A substrate 30 contains a surface 32 containing a discontinuity such as a crack 34, such as a service-induced crack in a superalloy component of a gas turbine engine, as shown in FIG. 4. The crack 34 may contain contaminants which are difficult or impossible to remove with known cleaning processes. In this embodiment, a layer of powdered material 36 is placed onto the surface 32 over the crack 34. The powdered material 36 includes a flux material, but in other embodiments may include or be only an alloy filler material, as more fully described below. An electro/mechanical transducer 38 is positioned in contact with the substrate 30 at a location adequate for the introduction of vibratory mechanical energy into the substrate 30 proximate the crack 34.

FIG. 5 illustrates the substrate 30 of FIG. 4 being exposed simultaneously to both a laser beam 40 (source not illustrated) and mechanical vibratory energy 42 produced by the transducer 38. While illustrated as a laser beam 40 in FIG. 5, other embodiments of the invention may utilize another type of beam energy, such as an ion beam, electron beam, etc. The mechanical vibratory energy 42 may be of any or varying frequencies, and in one embodiment is ultrasonic energy. The combined effect of the laser beam 40 and mechanical vibratory energy 42 is melting of the substrate 30 surrounding the crack 34 and melting of the overlying powdered material 36, thereby producing a melt pool 44 and, for the embodiment of powdered flux material 36, an overlying layer of slag material 46. As taught in commonly assigned United States patent application publication number US 2013/0136868 A1, incorporated by reference herein, flux material is advantageously effective to trap laser energy, provide atmospheric shielding, cleanse contaminants, control cooling, and optionally to provide a material additive function, making it particularly useful for the repair of difficult to weld superalloy materials.

FIG. 6 illustrates the substrate 30 after cooling and solidification of the melt pool 44 and layer of slag material 46, and FIG. 7 illustrates the substrate 30 after removal of the slag material 46, revealing a renewed surface 48 free of any discontinuity.

The application of vibratory mechanical energy 42 during the formation of the melt pool 44 in FIG. 5 provides agitation which can promote mixing, agglomeration and floatation of contaminants captured in the slag. The vibratory mechanical energy 42 may also or alternatively be applied before the formation of the melt pool 44, such as in the step of FIG. 4, in order to dislodge contaminants within the crack 34 and/or to create heat within the crack 34 via friction between opposing sides of the crack 34. The vibratory mechanical energy 42 may also or alternatively be applied after the formation of the melt pool 44, such as in the step of FIG. 6, in order to dislodge the layer of slag 46 and/or to provide a vibratory stress relief function.

Flux material may be applied over the crack 34 in powder, paste, liquid or foil form, and it may be preplaced, as shown in FIG. 4, or it may be applied concurrently with the application of the beam energy with a known feeder system. The flux may contain an additive constituent which alloys into the melt pool 44 to achieve a desired material composition or to compensate for a material that is lost as a result of the beam melting process, for example titanium or aluminum. A filler material powder may be included with the flux, the filler material powder contributing to the melt pool in order to add volume to compensate for discontinuity voids or to alter the chemical composition of the melt pool.

In one embodiment, a flux material is introduced into the discontinuity in the form of a liquid or paste. Beam energy is then applied to pre-heat the substrate material to a temperature close to but below a melting point of the substrate material. Mechanical vibratory energy is then applied to dislodge contaminants within the discontinuity and to create additional heat within the discontinuity due to friction, resulting in the formation of a small melt pool immediately around the discontinuity. The flux then functions to float the contaminants out of the melt pool as slag, which is then removed upon cooling and re-solidification of the melt pool.

It may be advantageous in this or other embodiments for the flux to include a composition that becomes exothermic when melted in order to further enhance and control the heating process. The exothermic agent may be any substance that undergoes a chemical reaction to produce heat. In some embodiments the exothermic agent is metal, metal alloy or metal composition which reacts with oxygen to produce heat. One example of such a reaction is the combustion of zirconium metal with oxygen to form zirconium oxide as shown below in equation (A):

Zr(s)+O₂→ZrO₂(s) (A)

Other examples of similar exothermic reactions which may be useful for specific applications include:

Fe₂O₃+2Al→2Fe+Al₂O₃(iron thermite) (B)

3CuO+3Al→3Cu+Al₂O₃(copper thermite) (C)

In another embodiment, a powder, liquid, paste or foil material is applied over the surface in a region of a discontinuity, and both mechanical vibratory energy and an energy beam are then applied to the substrate in the region of the discontinuity to melt and to distribute the applied material. The melted material is then allowed to solidify to from a repaired surface on the substrate.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A process for repair of a surface of a substrate, the process comprising:
imparting mechanical vibratory energy to the surface in a region of a discontinuity;
melting a portion of the surface including the discontinuity with an energy beam to form a melt pool; and
allowing the melt pool to solidify to form a renewed surface on the substrate without the discontinuity.

2. The process of claim 1, wherein the mechanical vibratory energy is imparted to the surface at least prior to the step of melting.

3. The process of claim 1, wherein the mechanical vibratory energy is imparted to the surface at least during the step of melting.

4. The process of claim 1, wherein the mechanical vibratory energy is imparted to the surface at least after the step of melting.

5. The process of claim 1, further comprising imparting the mechanical vibratory energy as ultrasonic energy and melting the portion of the surface with a laser beam.

6. The process of claim 1, further comprising:
depositing flux onto the surface over the discontinuity;
melting the flux during the step of melting a portion of the surface, the melted flux forming a layer of slag over the melt pool; and
removing the layer of slag to reveal the renewed surface.

7. The process of claim 6, further comprising applying the flux as a paste or liquid effective to infiltrate the discontinuity prior to the step of melting.

8. The process of claim 6, further comprising applying a filler material powder with the flux over the discontinuity, the filler material powder contributing to the melt pool upon being melted by the energy beam.

9. The process of claim 6, further comprising applying the flux to comprise an additive constituent, the additive constituent contributing to the melt pool upon being melted by the energy beam.

10. The process of claim 6, further comprising applying the flux to comprise a composition that is exothermic during the melting step.

11. The process of claim 1, wherein the substrate comprises a superalloy material, and further comprising:
applying a flux material to the superalloy surface over the discontinuity;
melting the flux material with the portion of the surface to form a layer of slag over the melt pool; and
removing the layer of slag to reveal the renewed superalloy surface.

12. A process for repair of a surface of a substrate, the process comprising:
applying a material over the surface in a region of a discontinuity;
applying both mechanical vibratory energy and an energy beam to the substrate in the region of the discontinuity to melt at least the applied material; and
allowing the melted material to solidify to from a repaired surface on the substrate.

13. The process of claim 12, further comprising:
applying the material as a flux material;
applying the mechanical vibratory energy and energy beam such that a portion of the substrate containing the discontinuity melts with the flux material to form a melt pool with an overlying layer of slag; and
removing the layer of slag to reveal the repaired surface.

14. The process of claim 12, further comprising:
applying the material as a flux material;
applying the energy beam to heat the substrate proximate the discontinuity to a temperature below its melting temperature;
applying the mechanical vibratory energy effective to generate heat within the discontinuity as a result of friction sufficient to cause melting of the substrate at the discontinuity to form a melt pool, with melted flux material forming a layer of slag on the melt pool; and
removing the layer of slag to reveal the repaired surface.

15. A process for repair of a surface of a substrate comprising the application of an energy beam and vibratory mechanical energy to the surface in a region of a discontinuity.

16. The process of claim 15, further comprising applying the vibratory mechanical energy at least prior to the application of the energy beam.

17. The process of claim 15, further comprising applying the vibratory mechanical energy at least during the application of the energy beam. The process of claim 15, further comprising applying the vibratory mechanical energy at least after the application of the energy beam.

19. The process of claim 15, further comprising:
depositing flux onto the surface over the discontinuity;
melting the flux and a portion of the surface containing the discontinuity with the energy beam to form a melt pool with a layer of slag over the melt pool; and
removing the layer of slag to reveal a renewed surface on the substrate.

20. The process of claim 15, further comprising:
depositing a filler material over the surface; and
melting the filler material with at least one of the energy beam and vibratory mechanical energy to form a renewed surface.
